(19) United States
(12) Patent Application Publication
(10) Pub. No.: US 2012/0265398 A1
(43) Pub. Date: Oct. 18, 2012

(54) SYSTEM AND ON-BOARD COMPUTER FOR CONTROLLING THE AUTOMOTIVE VEHICLES MAINTENANCE

(76) Inventor: Marcelo Campi Lima, Belo Horizonte (BR)

(21) Appl. No.: 11/915,853

(22) PCT Filed: Apr. 17, 2007
(86) PCT No.: PCT/BR2007/000159

§ 371 Date: Jan. 25, 2011

(30) Foreign Application Priority Data
Feb. 1, 2007 (BR) PI070013-2

(51) Int. Cl. G06F 17/00

(52) U.S. Cl. 701/36; 701/1

(57) ABSTRACT

The system for controlling the automative vehicles maintenance according to the invention comprises an on-board computer and a specific program for the on-board computer to manage automative vehicle maintenance. The on-board computer comprises an external feeding source (2), a tension regulator and electrical protection system (3), battery (4), real time clock (5), processing and control system (6), data storage system (7), an interface comprising a display (8A), a keyboard (8B), and a sound source (8C), bidirectional internal communication interfaces (9) for communication with an external computer (10), as well as an activating system (11), a sensoring system (12) and software (7) using two main and dynamic inputs: traveled distance and passed time.

### FIELDS OF THIS PATENT

Automotive vehicles maintenance.

Quality of automotive vehicles maintenance.

Computer science. Maintenance control automation of automotive vehicles.

This patent comprises a System, a device—on-board computer—and a specific programming for the on-board computer and it is purposed to manage automatically the maintenance of land automotive vehicles, mainly automobiles and transport vehicles, such as buses, trucks and utilitarian cars.

### STATE OF THE ART

Like all machines created by Man, the land automotive vehicles need maintenance in order to be able to perform their functions safely and economically.

It is understandable that the fleet vehicles, such as buses purposed to the public transportation and trucks for the cargo transport, police vehicles, rental automobile fleets and types of vehicles for commercial use purposes, are the target of complex maintenance service managements, both for prevention and for fixing.

Only in Brazil we can cite many collective transportation companies that own bus fleets composed of more than a thousand vehicles, whose costs are around US$200,000.00 for each; now, a patrimony of this value and with such a responsibility, both as a company and socially, must be kept under safe and profitable operational conditions. For that, the companies keep control cards which are filled out manually—whose data are launched in automated control cards, which makes it an expensive process and likely to be in error.

In the case of private automobiles, even though such belongings constitute significant expressions of the personal or family patrimony and may not threaten their passengers' physical integrity, their maintenance control is far from ideal for many reasons, such as the countless occupations of modern life, the endless extension of the technological resources aggregated to modern automobiles that make their operation and maintenance manual extensive, hard and boring to be read.

Traffic experts worldwide address the following as the main causes of accidents:

1—the local atmospheric conditions, including the time of occurrence;

2—the conditions and design of the roads;

3—the mechanical conditions and the conservation state of the involved vehicles and of their tires;

4—the human factors, that is, tiredness of one or more than one of the drivers' involved in the accidents, the speed at which such vehicles were going, etc; Nowadays, such experts think the mechanical conditions and the tire conservation state of the vehicles involved in accidents are included in the “human factors”, since the social and legal responsibility of the vehicle drivers' obliges them to “keep them under perfect use conditions”, that is, with periodical maintenance being perfectly carried out and at the time periods designated by the manufacturers.

The insurance companies keep some agreement clauses, approved by the consumers' defense organs and validated by sentences legally judged, for which the responsibilities of the insurance companies cease in case of lack or flaw of the maintenance services.

Thus, according to the current State of the Art, we have on one hand the maintenance of professional fleets carried out at high costs and low safe standard and, on the other hand, the lack of professionalism in maintaining private vehicles, reinforced by the complexity of the use and maintenance manuals.

However, even though there is a clear awareness of these facts, up to the release of this patent, there hadn't been any automated system put on board of vehicles for the perfect, economical and safe management of the vehicle maintenance available on the market, while the number of vehicles components were increasing, whose maintenances should be made at several and different time periods, resulting in a bad maintenance management by the owners of the vehicles.

Criticism to the state of the art.

In spite of the great social, economical and of civil responsibility importances in the vehicle maintenance under perfect use conditions through the programmed maintenance perfectly carried out at the correct time periods, the market response is nonexistent for the case of private vehicles and it is expensive and unsafe for the fleet vehicles and for professional applications.

It can be stated that the only automated resource put on board of the vehicles is the automated tachometer whose mission is to record, in periods of time shorter than tenths of seconds, the variations of speed, stopped time periods, brakes, etc., with the aim of controlling the drivers' performance.

Thus, due to the fact of the non-existence of a specific State of the Art as to placing automated systems and their devices on board of automotive vehicles purposed to control their maintenance, the object of this patent is constituted of a radical innovation in the widest concept of the State of the Art of automotive vehicles maintenance.

Advances in the State of the Art brought up by the “SYSTEM AND ON-BOARD COMPUTER FOR CONTROLLING THE AUTOMOTIVE VEHICLES MAINTENANCE”, object of this patent.

The “SYSTEM AND ON-BOARD COMPUTER FOR CONTROLLING THE AUTOMOTIVE VEHICLES MAINTENANCE”, object of this patent, which innovates radically the State of the Art of vehicles maintenance, is constituted of a System and its electronic devices and computer programs to be installed on board of automotive vehicles, which ruptures definitely with the previous paradigm, which was the control with cards whose filling out was made through manual data collection rather than automatedly.

Besides, the “SYSTEM AND BOARD COMPUTER FOR CONTROLLING THE AUTOMOTIVE VEHICLES ON-MAINTENANCE”, object of this patent, is consisted of a system, devices and software that comply with the Total Quality spirit, that is, it allows a Total Traceability of the control target and, thus, makes the Certification basis and the public faith of fulfilling the requirements for automotive vehicle maintenances with the following social and economical advantages:

1—Advance in the actions related to the Social Responsibility to the human life by the fact that it helps the owners to keep the circulating vehicles under perfect maintenance conditions;

2—Increase of the economical and social gains by the obstinate achievement of the advantages of the programmed preventive maintenance;

3—Gains with the suspension of losses by vehicle traffic interruption caused by the lack of programmed preventive maintenance;

4—Increase of the value for reselling used vehicles, whether private or from fleets, by the certification of suitable maintenance;

5—Decrease of the values charged by the insurance companies due to the decrease of accident risks by the conservation of the fleet under technical use conditions.

Description, Illustrations and work of the “SYSTEM AND ON-BOARD COMPUTER FOR CONTROLLING THE AUTOMOTIVE VEHICLES MAINTENANCE”, object of this patent.

The “SYSTEM AND ON-BOARD COMPUTER FOR CONTROLLING THE AUTOMOTIVE VEHICLES MAINTENANCE”, object of this patent, is consisted of a System formed by a specific hardware, conceived, projected and manufactured for this purpose, in which lies the specific software which is compatible, conceived and carried out for this purpose.

The software of this “SYSTEM AND ON-BOARD COMPUTER FOR CONTROLLING THE AUTOMOTIVE VEHICLES MAINTENANCE”, according to the law, will be registered at the specific Governmental Office; the diagrams of its specific hardware and software will be described in this Patent Report, as well as its inputs and output reports.

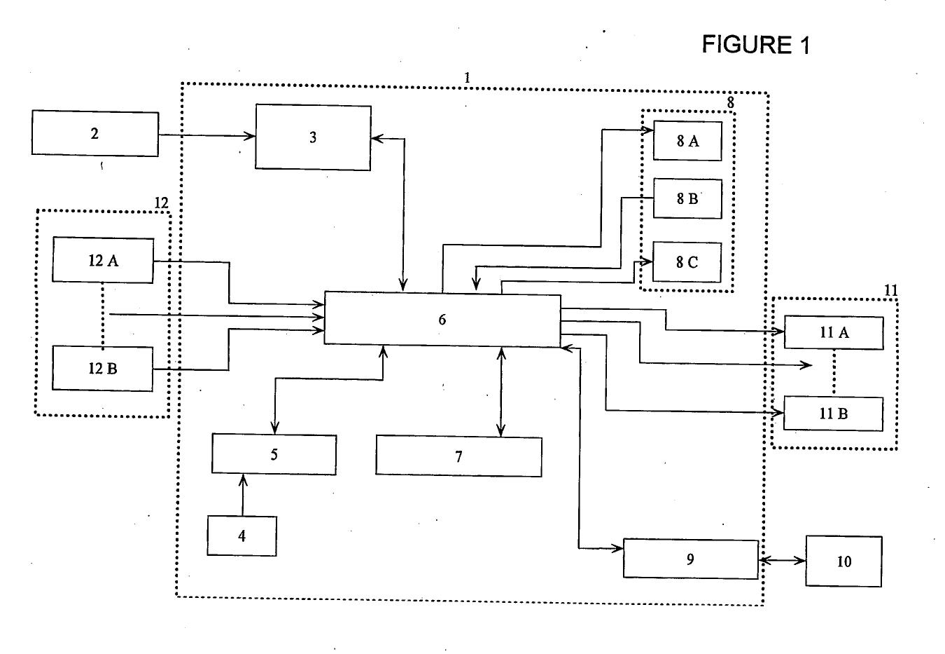

FIG. 1 is the diagram of the hardware functional components blocks of the “SYSTEM AND ON-BOARD COMPUTER FOR CONTROLLING THE AUTOMOTIVE VEHICLES MAINTENANCE”(1) where its components are shown and in which their interlinks are shown by the arrows; the External Feeding Source (2) can be seen, which, in practice, is consisted of the vehicle battery, the Tension Regulator and Electrical Protection System (3), the Battery (4) to keep the Real Time Clock (5) working, in case the External Feeding Source (2) is turned off, the Sensor System (12), able to receive signals from “n” sensors but fundamentally enabled to receive the digital signal from the sensor (12A) originally from the speedometer cable and/or from the vehicle digital odometer, or from analog or mechanical signal turned into a digital signal by a conventional converter, which doesn't have to be specified in the Patent Report; in this diagram we can also see the computer system core that is consisted of the microprocessor “chip” (6) that carries out the Control and Processing System of the “SYSTEM AND ON-BOARD COMPUTER FOR CONTROLLING THE AUTOMOTIVE VEHICLES MAINTENANCE”(1), The Data Storing System (7), the “Man-Machine” Interface System that comprises the Display (8C), the Keyboard (8B) and the Sound Source (8C), the Bidirectional Internal Communication Interfaces (9) between the “SYSTEM AND ON-BOARD COMPUTER FOR CONTROLLING THE AUTOMOTIVE VEHICLES MAINTENANCE”(1), and an external computer (10) as well as the Activating System (11), composed of the Activators (11A) . . . (11N).

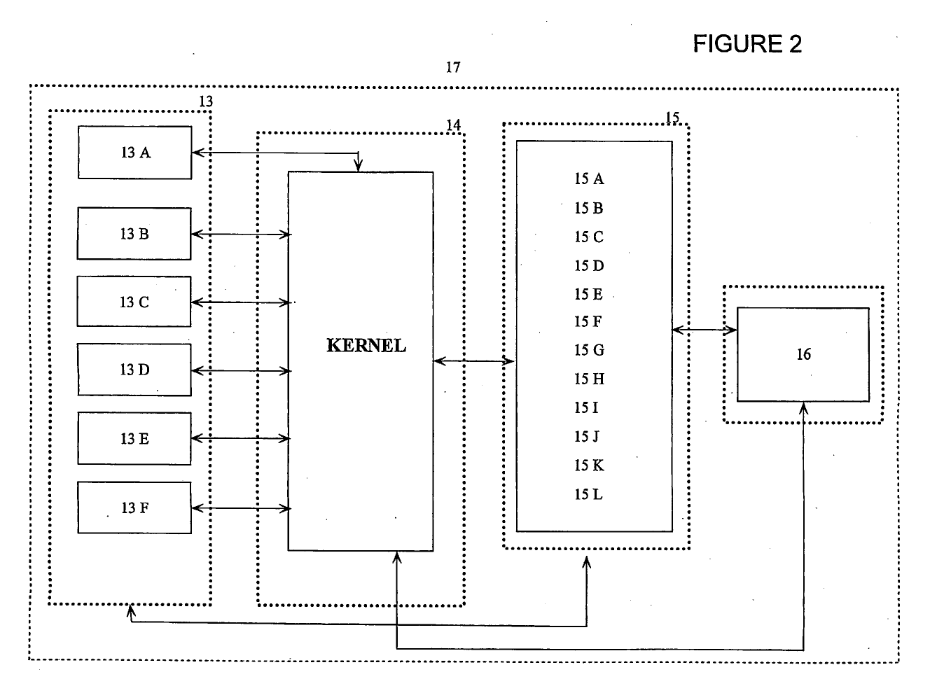

FIG. 2 shows in a block diagram, the Software (17) of the “SYSTEM AND ON-BOARD COMPUTER FOR CONTROLLING THE AUTOMOTIVE VEHICLES MAINTENANCE”(1); we can see in it the Peripheral Drivers (13), composed of the Keyboard Driver (13A), Display Driver (13B), Audio Driver (13C), Clock Driver (13D), Sensor and Activating Drivers (13E) and Another Peripheral Driver (13F), the Operational System (14), the Database (16) which contains the Settings, background and information about the vehicle, and the Application Set (15), composed of the following applications:
Information about the Vehicle (15A), programmed, non-programmed and performed Maintenance Control (15B), Fuel Consumption Control (15C), Speed Control (15D), Odometer and Calibration Control (15E), Travel Control (15F), Warning Control Center (15G), Memo (15H), Settings (15I), Statistics (15J), Connectiveness (15K), to enable the data transmission and reception, Information Calculation and Storage (15L).

The work of the “SYSTEM AND ON-BOARD COMPUTER FOR CONTROLLING THE AUTOMOTIVE VEHICLES MAINTENANCE” (1) consisting of processing—through the software (17)—the input data, listed as follows, which will be processed to originate the reports and products that support this patent, from the two main and dynamic inputs, which are the distance traveled by the vehicle and the time passage.

The distance traveled by the vehicle—that can be recorded either in kilometers on in miles—will be simply called “mileage” from now on and it will be automatically sent to the software (17) through the signal received by the Sensor (12A) of the “SYSTEM AND ON-BOARD COMPUTER FOR CONTROLLING THE AUTOMOTIVE VEHICLES MAINTENANCE” (1) in the gear box output, from the vehicle odometer or speedometer cable.

This signal may come from the gear box in three different ways:

1st signal type—a mechanical signal, in a steel cable rotating core rotation way;

2nd signal type—analog electric signal under a variable tension applied to the electric cable;

3rd signal type—digital electric signal.

The “SYSTEM AND ON-BOARD COMPUTER FOR CONTROLLING THE AUTOMOTIVE VEHICLES MAINTENANCE”(1) will directly process the information in a digital signal way; in the case of analog electric signal or mechanical signal, such signals will be turned into digital signal by sensors that are available on the market, thus making the “SYSTEM AND ON-BOARD COMPUTER FOR CONTROLLING THE AUTOMOTIVE VEHICLES MAINTENANCE” (1) able to be applied to all the worldwide vehicle fleet in an extremely simple way.

At the moment of the installation of the “SYSTEM AND ON-BOARD COMPUTER FOR CONTROLLING THE AUTOMOTIVE VEHICLES MAINTENANCE” (1), it will be calibrated according to the signals, already turned into digital signals, provided to the vehicle odometer; in case the vehicle is not new, that is, with the odometer marking zero traveled kilometers, the existing mileage will be taken into consideration by the “SYSTEM AND ON-BOARD COMPUTER FOR CONTROLLING THE AUTOMOTIVE VEHICLES MAINTENANCE” (1).

For simplification matters, during the description of the functions carried out by the “SYSTEM AND ON-BOARD COMPUTER FOR CONTROLLING THE AUTOMOTIVE VEHICLES MAINTENANCE” (1):

A—It will be simply treated as System (1);

B—The Software (17) Processing and Control System (6), through the Bidirectional External Communication Interfaces (9) will be able to communicate with External Computers (10) in order to receive or send data as well as to receive data through the Keyboard (8B);

C—The signals derived from the speedometer/odometer cable of the Sensoring System (12), of the Real Time Clock (5) and the other pieces of information received through the Keyboard (8B) or through the Bidirectional Communication Interfaces (9) will be processed by the Software (17) thus generating the reports of the System (1), according to what has been requested by striking the proper keys that compound the Keyboard (8B), which are conceived and programmed to be used by the users in a friendly way.

The operations of data input and output reports are the functions carried out by the System (1) that characterize it, as follows:

1—Release of warning on the Display (8A)—visual and/or sound—of the need to carry out the Programmed Maintenance due to the traveled mileage;

2—Idem, due to predetermined time span in scheduling the maintenance;

3—In both of the cases above, the release of warning on the Display (8A), visual and/or sound—of the need for carrying out the Programmed Maintenance due to traveled mileage or due to previously determined date, can be programmed to occur at a safety margin, expressed in terms of percentage to be reached so that the programming isn't indicated exactly at the mileage or date it has to happen;

4—The programmed and performed maintenance information records will enter the System (1) through the Keyboard (8B) and they will allow their record according to the traveled mileage, dates, values and suppliers.

5—The System (1) will show background and statistics reports such as checking the data about the performed maintenances by type of job since the beginning of the records.

6—Such background can be checked by taking a certain period of time with date intervals into account.

In order to understand the interaction “user/System (1)” better, we show some examples of Reports produced by Check by Type of Maintenance, here, the Change of the Front Brake Pads, as follows.

Period: 2003/01/01 to 2004/12/31.

First check:

Date: 03/02/23

Km: 19,370

Supplier: Varga

Cost: R$60,00

Second Check:

Date:04/01/17

Km: 32,290

Supplier: Oficina Planalto.

Cost: R$75,00

Third Check:

Date: 04/12/29

Km: 46,770

Supplier: Varga

Cost: R$87,00

TOTAL 222,00

Report example by supplier's check:

Supplier: Varga.

Period: from 2003/01/01 to 2004/12/31.

Date: 03/02/23; Km: 19,370; Cost: R$60,00.

Date: 04/12/29; Km: 46,770; Cost: R$87,00.

TOTAL 142,00

7—Release of Report on consumption of various types of fuel—Gasoline, alcohol, Natural Gas—for a certain period, with date intervals.

8—Release of Reports on costs for each of the various types of fuels with date intervals, showing the suppliers and the costs of each refilling operation.

9—Release of Expense Reports on each fuel supplier.

10—Release of Report on the Average Cost per Km, taking the expenses on fuel, pieces and maintenance into consideration, per period between dates or per mileage interval.

11—Memo Report with all information about all the piece and service suppliers, containing cellular phone numbers and others for searching for help in emergencies.

12—The System (1) Display (8A) constantly shows the pieces of information as listed below, and it allows the access to the other software option menus and sub-menus.

A—Date and Time;

B—Vehicle Identification (plate);

C—Warning about the maintenance to be performed;

D—Vehicle speed;

E—Software option related to the Keyboard (8B) left control key;

F—Software option related to the Keyboard (8B) right control key;

G—Partial Odometer;

H—Total Odometer;

I—Sound warning of speed excess;

J—Maintenance visual warning;

K—Maintenance sound warning;

13—Choices in the “Menu” option, by using the Keyboard (8B):

A—Record the Maintenance;

B—Alter;

C—Confirm;

D—Exit;

E—Back;

F—Confirm;

G—Cancel.

14—Use the alphanumerical Keyboard (8B) to add the information related to maintenances, memo and other settings, by a similar digitation to that of the cellular phone, and the Keyboard (8B) can be used to enter texts about all the background events of the vehicle.

15—Surf the Menu and do as many operations as possible by using the Keyboard (8B) proper key in a suitable way.

16—Carry out jobs by choosing the Keyboard (8B) proper key in a suitable way; jobs such as:

A—Choose Option;

B—Confirm;

C—Select;

D—Cancel;

E—Back;

F—Delete;

G—Clear;

H—Exit;

17—Make the surfing easier as the Software (17) allows that for each key shown on the Display (8A), the surfing control left key will have a different function from that of the surfing control right key.

18—Allow that, by pressing the Keyboard(8B) properly, the System Hardware (1) is taken out from its fixed support for information maintenance purposes.

19—Allow the System (1) Hardware to be turned off and taken out, transported and kept somewhere else for safety purposes.

20—Allow the quick access to some of the System (1) functions by pressing the proper keys on the Display (8A), such as in order to release sound or visual signals so that they are enabled or disabled.

21—Allow the quick access to enable or disable the maintenance warning sound signal.

22—Allow the quick access to enable or disable the maintenance warning visual signal.

23—Allow the quick access to enable or disable the speed limit excess warning sound signal.

24—Allow the quick access to the System (1) to include the data of a maintenance to be carried out or that has already been performed.

25—Allow quick access to the System (1) to include data about fuel filling.

26—Allow quick access to the “main screen presentation setting” mode.

27—Allow the quick access to the System (1) to open the “Travel Background Formation”.

28—Allow the quick access to the System (1) to enter the “speed limit alteration” function.

29—Allow the quick access to the System (1) to enter the Memo.

30—Allow the quick access to the System (1) to enter the “statistics” functions.

31—Allow the “Surfing General Menu” to be structured similarly to the cellular telephone Acting General Menu, so that it is easy to be learned and used and that the following operations can be intuitive ones:

32—Menu (Main Screen).

33—My vehicle.

34—Fuel Consumption.

35—Control Consumption.

36—Search.

37—Add.

38—Edit.

39—Delete.

40—Define types of Fuel.

41—Search

42—Add.

43—Edit.

44—Delete.

45—Maintenances.

46—Standard Maintenance.

47—Search.

48—Add.

49—Edit.

50—Delete.

51—Programmed Maintenances.

52—Search

53—Add.

54—Edit.

55—Delete.

56—Define Active Sound Warning Control.

57—Define Active Visual Warning Control.

58—Speed.

57—Define Speed Limit.

58—Define Sound Warning Control when reaching the Speed Limit.

59—Define Visual Warning Control when reaching the Speed Limit.

60—Odometer.

61—Start the Odometer.

62—Correct the Odometer.

63—Zero Partial Odometer.

64—Memo.

65—Select Types of Suppliers (Mechanic Garages, Service Stations, etc.)

66—Search.

67—Add.

68—Edit.

69—Delete.

70—Memo Control.

71—Search.

72—Add.

73—Edit.

74—Delete.

75—Travel.

76—Search.

77—Add.

78—Conclude.

79—Edit.

80—Delete.

81—Define Main Screen.

82—Inactivity.

83—Set Date and Time.

84—Warning rings.

85—Maintenances.

86—Types of Rings.

87—Volume Intensity.

88—Speed Limit.

89—Types of Rings.

90—Volume Intensity.

91—Idiom.

92—Define Security Code.

93—Delete Information.

94—Statistics.

95—Fuel Consumption.

96—Programmed Maintenances.

97—Performed Maintenances.

98—Supplier's Background.

99—Expense Background.

100—Traveled Kilometer Average.

101—Traveled Distance expressed in Kilometers or Miles.

102—Connectiveness.

103—Send information to the computer.

104—Receive Information from the computer.

105—Applications.

106—Calculator.

107—Calendar.

1. “SYSTEM AND ON-BOARD COMPUTER FOR CONTROLLING THE AUTOMOTIVE VEHICLES MAINTENANCE”, which comprises a System, a device—onboard computer—and a specific programming for the onboard computer and it is purposed to manage automatically the land automotive vehicle maintenance, mainly automobiles and cargo vehicles such as buses, trucks and utilitarian, characterized by being constituted of a hardware with an External Feeding Source (2), Tension Regulator and Electrical Protection System (3), Battery (4), Real Time Clock (5), Processing and Control System (6), Data Storage System (7), Interface that comprises the Display (8A), the Keyboard (8B) and the Sound Source (8C), the Bidirectional Internal Communication Interfaces (9), External Computer (10), as well as the Activating System (11), composed of the Activators (11A) . . .(11N), Sensoring System (12) and Software (17) that use two main and dynamic inputs: vehicle traveled distance and time passage.

2. “SYSTEM AND ON-BOARD COMPUTER FOR CONTROLLING THE AUTOMOTIVE VEHICLES MAINTENANCE”, according to claim 1, characterized by Sensoring System (12) which is able to receive signals from “n” sensors but, specially, able to receive the digital signal from the original sensor (12A) of the vehicle speedometer or digital odometer cable, or from an analog or mechanical signal converted into a digital one by a conventional converter acquired from the gear box output through the vehicle odometer or speedometer cable.

3. “SYSTEM AND ON-BOARD COMPUTER FOR CONTROLLING THE AUTOMOTIVE VEHICLES MAINTENANCE”, according to claim 1, characterized by Software (17) that contains the Peripheral Drivers (13) composed of the Keyboard Driver (13A), the Display Driver (13B), Audio Driver (13C), Clock Driver (13D), Activators and Sensors Driver (13E) and Driver for Another Peripheral (13F), the Operational System (14), the Database (16) that contains the Settings, Vehicle Background and the Applications Set (15).

4. “SYSTEM AND ON-BOARD COMPUTER FOR CONTROLLING THE AUTOMOTIVE VEHICLES MAINTENANCE”, according to claim 3, characterized by the fact that the Application Set (15) is composed of the Vehicle Information (15A), programmed, non-programmed and performed Maintenance Control (15B), Fuel Consumption Control (15C), Speed Limit Control (15D), Odometer and Calibration Control (15E), Travel Control (15F), Warning Control Center (15G), Memo (15H), Settings (15I), Statistics (15J), Connectivenness (15K), to enable the transmission and reception of the data, Information Calculation and Storage (15L).

5. “SYSTEM AND ON-BOARD COMPUTER FOR CONTROLLING THE AUTOMOTIVE VEHICLES MAINTENANCE”, according to claim 1, characterized by the fact that the System (1) generates reports that are processed by the Software (17) from the signals derived from the speedometer/odometer cable of the Sensoring System (12), of the Real Time Clock (5) and other information received through the Keyboard (8B) or through the Bidirectional Communication Interfaces (9).

6. “SYSTEM AND ON-BOARD COMPUTER FOR CONTROLLING THE AUTOMOTIVE VEHICLES MAINTENANCE”, according to the previous claims, characterized by the fact that the System (1) releases a warning on the Display (8A)—visual and/or sound—about the occurrence of the need of carrying out a Programmed Maintenance due to the traveled mileage or due to the time span of a predetermined deadline for a maintenance scheduling.

7. “SYSTEM AND ON-BOARD COMPUTER FOR CONTROLLING THE AUTOMOTIVE VEHICLES MAINTENANCE”, according to the previous claims, characterized by the fact that the System (1) allows the data input through the keyboard with their recording according to the traveled mileage, dates, values and suppliers.

8. “SYSTEM AND ON-BOARD COMPUTER FOR CONTROLLING THE AUTOMOTIVE VEHICLES MAINTENANCE”, according to claim 7, characterized by the fact that the data input through the keyboard (8B) allows a quick access to include the data about a fuel filling, data about a maintenance to be performed or an already carried-out one, enabling or disabling the sound and visual signal releases and the other alterations inherent to the system.

9. “SYSTEM AND ON-BOARD COMPUTER FOR CONTROLLING THE AUTOMOTIVE VEHICLES MAINTENANCE”, according to the previous claims, characterized by the fact that the System (1) generates background and statistics reports, such as data checks on the performed maintenance by service type since the beginning of the records.

10. “SYSTEM AND ON-BOARD COMPUTER FOR CONTROLLING THE AUTOMOTIVE VEHICLES MAINTENANCE”, according to the previous claims, characterized by the fact that the System (1) generates reports about the various types of fuel—Gasoline, Alcohol and Natural Gas—for a certain period with date intervals.

11. “SYSTEM AND ON-BOARD COMPUTER FOR CONTROLLING THE AUTOMOTIVE VEHICLES MAINTENANCE”, according to the previous claims, characterized by the fact that the System (1) generates reports about the costs on each of the various types of fuel at date intervals, addressing the suppliers and values of each refilling operation.

12. “SYSTEM AND ON-BOARD COMPUTER FOR CONTROLLING THE AUTOMOTIVE VEHICLES MAINTENANCE”, according to the previous claims, characterized by the fact that the System (1) generates reports on the Average Cost per Km, taking the expenses on fuel, pieces and maintenance into account, in periods between dates or by mileage interval.

13. “SYSTEM AND ON-BOARD COMPUTER FOR CONTROLLING THE AUTOMOTIVE VEHICLES MAINTENANCE”, according to the previous claims, characterized by the fact that the System (1) generates Memo reports with all the information about the piece and service suppliers, containing their cellular telephone numbers among others, in order to search for help in case of emergencies.

14. “SYSTEM AND ON-BOARD COMPUTER FOR CONTROLLING THE AUTOMOTIVE VEHICLES MAINTENANCE”, according to the previous claims, characterized by the fact that the System (1) shows constantly the Date and Time, Vehicle Identification (plate), Warning about maintenance to be carried out; Vehicle Speed; Software Option related to the Keyboard (8B) Left Control Key, Software Option related to the Keyboard (8B) Right Control Key; Partial Odometer; Total Odometer; Speed Limit Excess Sound Warning; Maintenance Visual and Sound Warning; Choices in the “Menu” option by means of the Keyboard (8B): Maintenance Recording; Alter; Confirm; Exit; Back; Confirm and Cancel on the Display (8A).

15. “SYSTEM AND ON-BOARD COMPUTER FOR CONTROLLING THE AUTOMOTIVE VEHICLES MAINTENANCE”, according to the previous claims, characterized by the fact that the System (1) allows the introduction of the information related to the maintenances, memo and other settings, as well as texts related to all the vehicle background events by means of the alphanumerical Keyboard (8B).

16. “SYSTEM AND ON-BOARD COMPUTER FOR CONTROLLING THE AUTOMOTIVE VEHICLES MAINTENANCE”, according to the previous claims, characterized by the fact that the System (1) Hardware can be separated from the vehicle fixed support for information maintenance matters.

17. “SYSTEM AND ON-BOARD COMPUTER FOR CONTROLLING THE AUTOMOTIVE VEHICLES MAINTENANCE”, according to the previous claims, characterized by the fact that the System (1) allows that the “Surfing General . Menu” to be structured similarly to the Acting General Menu of Cellular telephones, providing: Menu (Main Screen); My Vehicle; Fuel Consumption; Consumption Control; Search; Add; Edit; Delete; Define Types of Fuel; Maintenances; Standard Maintenances; Programmed Maintenances; Define Active Sound Warning Control; Define Active Visual Warning Control; Speed; Define Speed Limit; Define Sound Warning Control when reaching the Speed Limit; Define Visual Warning Control when reaching the Speed Limit; Odometer; Start the Odometer; Correct the Odometer; Zero the Partial Odometer; Memo; Select the Suppliers' Types; Memo Control; Travel; Conclude; Define the Main Screen; Inactivity; Set Date and Time; Warning Rings; Volume Intensity; Idiom; Define Security Code; Delete Information; Statistics; Fuel Consumption; Programmed Maintenances; Performed Maintenances; Suppliers' Background; Expenses Background; Average Value per Traveled Kilometer; Traveled Distance expressed in Miles or Kilometers; Connectiveness; Send Information to the Computer; Receive Information from the Computer; Applications; Calculator; Calendar.
